(19) United States
(12) Patent Application Publication
(10) Pub. No.: US 2008/0117837 A1
(43) Pub. Date: May 22, 2008

(54) METHOD FOR SETTING WIRELESS LAN COMMUNICATION SYSTEM AND WIRELESS LAN ACCESS POINT

(75) Inventor: Yoichiro KONDO, Chino-shi (JP)

Correspondence Address: OLIFF & BERRIDGE, PLC, P.O. BOX 320850, ALEXANDRIA, VA, 22320-4850, US

(73) Assignee: SEIKO EPSON CORPORATION, Tokyo (JP)

(21) Appl. No.: 11/941,557

(22) Filed: Nov. 16, 2007

(30) Foreign Application Priority Data
Nov. 22, 2006 (JP) 2006-315190

(51) Int. Cl. H04L 12/28

(52) U.S. Cl. 370/254

(57) ABSTRACT

A method for setting a wireless local area network (LAN) communication system that is connected to an external network via an access point in the case of adding a new extension terminal to the system includes: (a) acquiring, at a server, information identifying a new extension terminal from a user's device; (b) transmitting, while system data is set at the access point based on first setting information, second setting information regarding the new extension terminal from the server to the access point via an external network; (c) changing at the access point the system data based on the transmitted second setting information; (d) transmitting the first setting information from the access point to the new extension terminal; (e) changing at the new extension terminal the system data based on the transmitted first setting information; and (f) setting at the access point the system data based on the first setting information.

The entire disclosure of Japanese Patent Application No. 2006-315190, filed Nov. 22, 2006 is expressly incorporated by reference herein.

### BACKGROUND

1. Technical Field

The present invention relates to a method for setting an extension terminal newly added to wireless local area network (hereafter referred to as “wireless LAN”) and a wireless LAN access point that is a relay for the wireless LAN.

2. Related Art

In recent years, various services are widely provided by a wireless LAN communication system which performs wireless communication by connecting terminals such as computers to the Internet without using cable wiring. For example, in stations and airports where an access point is set as a relay, a user can connect the terminal to the Internet by accessing to the access point via the wireless LAN. In these public spaces, it is often the case that multiple businesses and services share one wireless LAN, thereby improving the use efficiency of space and radio waves.

The access point is set not only at the public spaces such as stations and airports but also at private spaces such as homes in which multiple computers can be connected to the Internet through the wireless LAN. Also, in recent years, devices connected to the Internet are not limited to computers but may also be other devices such as network cameras and portable game instruments, so that the user can enjoy various services using the Internet.

However, not all users using the system in public spaces such as stations and airports and private spaces such as homes are familiarized to the system or the devices. Therefore, it is desirable that a new extension terminal can be set in the wireless LAN communication system very simply.

Also, because data is sent and received using radio waves, the wireless LAN communication system involves security problems such as interception of radio waves by a third party or an unauthorized use of the access point. Example methods for raising the security level are: a data encrypting method using an encryption technique such as wired equivalent privacy (WEP), a filtering method using an address such as a media access control (MAC) address that is fixedly applied to the terminal, and a method for identifying the terminal at a short distance by using an infrared communication device.

If plural methods are combined, the security level is raised, but data setting becomes complex. Also, it becomes necessary to provide hardware other than the wireless LAN, such as the infrared communication device. To solve these problems, various techniques have been developed.

As a related technique, JP-A-2004-215232 (pp. 5 and 6, FIG. 3) discloses an encryption key setting system, in which a new terminal is added by a simple technique using a wireless LAN while preventing leakage of data representing an encryption key. This encryption key setting system is a system that sets an encryption key in the terminal. The encryption key is used to encrypt radio communication data transmitted between an access point that is a relay for the wireless LAN and a terminal equipped with a device for connecting with the wireless LAN prior to the transmission. The encryption key setting system includes: a communication range restriction module that restricts a radio communication range between the access point and the terminal to be narrower than a general communication range; and an encryption key setting module that, while the radio communication range is restricted by the communication range restriction module, transmits encryption key data representing the encryption key by wireless between the terminal and the access point located within the restricted radio communication range so as to set the encryption key.

It is stated that, according to this encryption key setting system, it is possible to prevent interception of wireless communication data and to raise the security level of the wireless LAN, because the encryption key and authentication code are transmitted while narrowing the radio communication range between the access point and the terminal. However, this system requires a module to restrict the radio communication range between the access point and the terminal to be narrower than the general communication range, and it is still difficult to completely prevent interception of the wireless communication data.

Also, JP-A-2005-303459 (p. 7, FIG. 3) discloses a wireless LAN system composed of an external wireless LAN terminal and an access point that is connected to a wired LAN and to the external wireless LAN terminal based on prescribed wireless LAN standards so as to mediate between the wired LAN and the wireless LAN. The access point contains a first ID data receiver that acquires first ID data by a non-contact technique outside the wireless LAN standards. The wireless LAN terminal is capable of sending out second ID data upon receipt of a connection request based on the wireless LAN standards. When the access point receives the connection request from the wireless IAN terminal based on the wireless LAN standards, the access point acquires the second data that has been sent out upon receipt of the connection request and connects to the wireless LAN terminal under a condition that the first ID data and the second data match.

It is stated that, according to this wireless LAN system, it is possible to start the connection between the wireless LAN terminal and the access point by a simple technique, because the connection is started using both the techniques by the wireless LAN standards and not by the wireless LAN standards. However, this system requires a communication unit such as a radio frequency identification (RFID) unit or an infrared communication unit in addition to the wireless LAN.

### SUMMARY

An advantage of the invention is to provide a method for easily setting a wireless local area network (LAN) communication system while ensuring a high security level when adding a new extension terminal to the system, and a wireless LAN access point used therefor.

According to a first aspect of the invention, a method for setting a wireless LAN communication system that is connected to an external network via an access point in the case of adding a new extension terminal to the system includes: (a) acquiring, at a server, information identifying a new extension terminal from a user's device; (b) transmitting, while system data is set at the access point based on first setting information, second setting information regarding the new extension terminal from the server to the access point via an external network; (c) changing at the access point the system data based on the transmitted second setting information; (d) transmitting the first setting information from the access point to the new extension terminal; (e) changing at the new extension terminal the system data based on the transmitted first setting information; and (f) setting at the access point the system data based on the first setting information.

According to a second aspect of the invention, a method for setting a wireless LAN communication system that is connected to an external network via an access point in the case of adding a new extension terminal to the system in addition to at least one existing terminal includes: (a) acquiring, at a server, information identifying a new extension terminal from a user's device; (b) transmitting, while system data is set at the access point based on first setting information, second setting information regarding the new extension terminal from the server to the access point via an external network; (c) transmitting the second setting information from the access point to the at least one existing terminal; (d) renewing, at the at least one existing terminal, the system data based on the second setting information using a renewal function of firmware; and (e) changing the system data of the access point based on the second setting information.

It is preferable that the step (a) include acquiring the second setting information regarding the new extension terminal from a user's mobile phone or computer.

According to a third aspect of the invention, a wireless LAN access point that connects a wireless LAN communication system to an external network includes: a storage that stores a plurality of types of setting information; a transmitter-receiver that transmits/receives a wireless signal to/from at least one terminal; and a controller that, while system data is set at the access point based on first setting information, acquires second setting information regarding a new extension terminal from a server via the external network, changes the system data of the access point based on the second setting information, controls the transmitter-receiver so as to transmit the first setting information to the new extension terminal so that the system data of the new extension terminal is changed based on the first setting information, and, thereafter, sets the system data based on the first setting information at the access point.

It is preferable that the transmitter-receiver include a first transmit-receive section that transmits/receives a wireless signal to/from at least one existing terminal and a second transmit-receive section that transmits/receives a wireless signal to/from the new extension terminal.

According to these aspects of the invention, by acquiring at the server the information identifying the new extension terminal from a user's device such as a mobile phone, a new extension terminal may be easily set while ensuring a high security level.

### BRIEF DESCRIPTION OF THE DRAWINGS

The invention will be described with reference to the accompanying drawings, wherein like numbers reference like elements.

FIG. 1 is a block diagram showing an exemplary structure containing a wireless LAN communication system in which a setting method of a first embodiment of the invention is implemented.

FIG. 2 is a block diagram showing the structure of an access point of FIG. 1.

FIG. 3 is a flow chart showing the method for setting the wireless LAN of the first embodiment of the invention.

FIG. 4 is a table showing one example of extension terminal setting information set at the extension terminal.

FIG. 5 is a table showing one example of wireless LAN setting information set at the access point.

FIG. 6 is a flow chart showing a method for setting a wireless LAN of a second embodiment of the invention.

FIG. 7 is a block diagram showing another exemplary structure containing the wireless LAN communication system in which the setting method of the first embodiment of the invention is implemented.

### DESCRIPTION OF EXEMPLARY EMBODIMENTS

Embodiments of the invention will now be described in detail with reference to the drawings. Identical elements are allotted with identical reference numbers, and descriptions thereof will not be repeated.

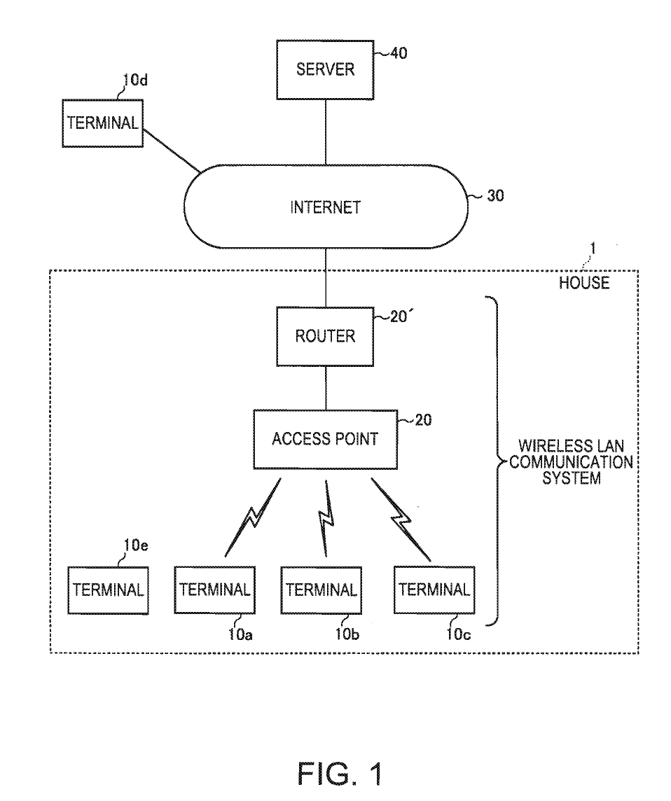

FIG. 1 is a block diagram showing an exemplary structure containing a wireless LAN communication system in which the setting method of the first embodiment of the invention is implemented. In the present embodiment, the wireless LAN communication system (hereafter referred simply as “wireless LAN”) is installed in a house 1. The wireless LAN communication system includes a plurality of client terminals (hereafter referred simply as “terminals”) 10a, 10b, etc., and a wireless LAN access point (hereafter referred simply as “access point”) 20. In FIG. 1, a terminal to be newly added to the wireless LAN is represented as an extension terminal 10e.

The terminals 10a through 10c are, for example, computers and network cameras. The access point 20 transmits/receives a wireless signal (radio waves) to/from the terminals 10a through 10c. With reference to FIG. 1, a network device such as a router 20′ may be placed between the access point 20 and Internet 30. Alternatively, the access point 20 may be integrated with other units such as the router 20′.

Using the wireless LAN system as shown in FIG. 1, the user is allowed to connect to the Internet 30 from the terminals 10a through 10c via the wireless LAN and enjoy various services given from a server 40 of a service provider connected to the Internet 30. Also, the user can use functions such as e-mail by using a terminal 10d placed outside the house 1 and accessing to the terminals 10a through 10c via the Internet 30.

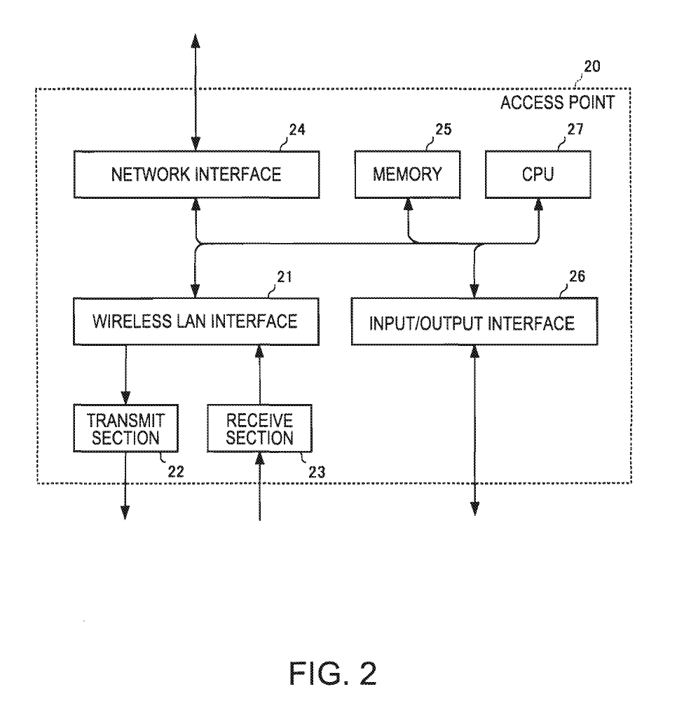

FIG. 2 is a block diagram showing the structure of the access point of FIG. 1. Referring to FIG. 2, the access point 20 includes: a wireless LAN interface 21, a transmit section 22, a receive section 23, a network interface 24, a memory 25, an input/output interface 26, and a central processing unit (CPU) 27.

The wireless LAN interface 21 generates and processes data used in the wireless LAN communication between the interface 21 and the plurality of terminals 10a to 10c shown in FIG. 1. The transmit section 22 modulates carrier waves based on transmitting data and transmits the signal as a wireless signal. The receive section 23 receives the wireless signal and demodulates the signal to acquire the transmitted data.

The access point 20 is connected to a network device such as the router via the network interface 24. The memory 25 stores data and programs that the access point 20 transmits/receives to/from outside. Based on the programs stored in the memory 25, the CPU 27 controls the wireless LAN interface 21, the network interface 24, the memory 25, and the input/output interface 26. The access point 20 is also equipped with a light-emitting diode (LED) lamp so that the user can check, e.g., the state of the network communication. Such an LED lamp, a power switch, etc., are connected to the input/output interface 26.

In the wireless LAN system as shown in FIG. 1, the plurality of terminals 10a to 10c are allowed to communicate with each other when the system data is set based on the setting information of the wireless LAN. Thus, when adding a new extension terminal to the wireless LAN, it is necessary to store the setting information of the wireless LAN as the system data in that extension terminal.

Such setting information is stored in the memory 25 in the access point 20 as shown in FIG. 2. Hereunder, the setting information of the wireless LAN communication system composed of the access point 20 and the terminals such as 10a to 10c is referred to as “wireless LAN setting information.”

Also, in general, the wireless LAN setting information and a system data changing program used when changing the system data are stored in the memory of the terminals such as 10a to 10c. Hereunder, the setting information stored prior to connection of the extension terminal 10e to the wireless LAN is referred to as “extension terminal setting information.”

Upon receipt of necessary information from outside, the system data changing program is started so as to change the system data. The necessary information in order to operate the system data changing program represents information such as procedures, various commands, and passwords needed to change the system data. Also, the memory 25 of the access point 20 stores, in addition to the regular wireless LAN setting information, a setting change application program that initiates the system data changing program stored in the terminals of the wireless LAN.

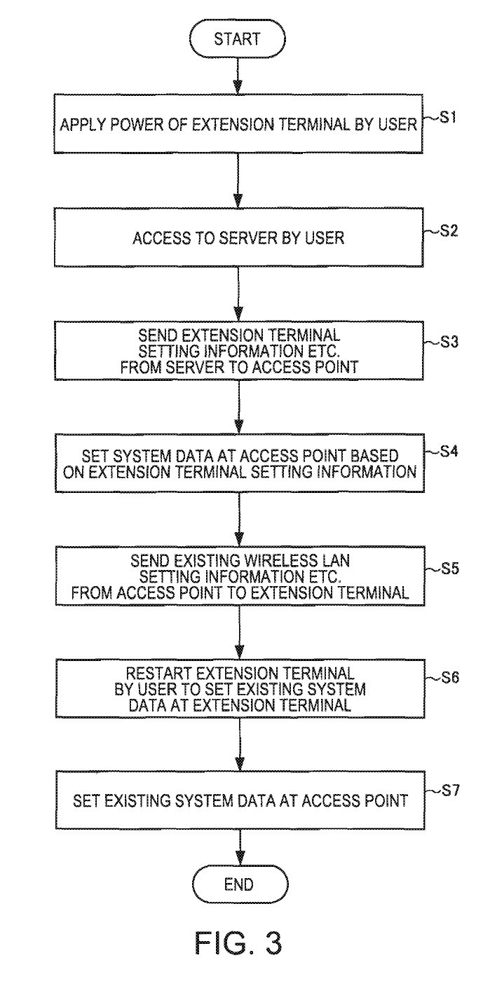

The procedure for establishing the setting information required for connection of the extension terminal 10e to the wireless LAN will now be explained with reference to FIGS. 1 through 3. FIG. 3 is a flow chart showing the method for setting the wireless IAN of the first embodiment of the invention.

First, in step S1 of FIG. 3, the user applies power of the extension terminal 10e to be connected to the wireless LAN, so that the state of the wireless LAN interface mounted on the extension terminal 10e becomes operable. With shipment, the extension terminal 10e is allotted a specific serial number and stores system data based on the initial setting information (extension terminal setting information). Such a serial number and extension terminal setting information are controlled at a special server (hereafter referred to as “server”) 40 that is connected to the Internet 30.

The server 40 and the access point 20 are allotted a telephone number starting with, for example, “050,” and are accessible using the telephone number from, e.g., a mobile phone through the Internet 30. The server 40 controls the telephone number of the access point 20.

Then, in step S2, the user accesses to the server 40 using, e.g., a mobile phone. The user acquires in advance information such as a telephone number, a uniform resource locator (URL), and a password from a service provider and, based on this information, can access a special website provided by the server 40.

At the special website, the user inputs a serial number (e.g., 123456) allotted to the extension terminal 10e to be connected to the wireless LAN and a telephone number (e.g., 050-1234-5678) allotted to the access point 20. On this basis, the server 40 retrieves the extension terminal setting information corresponding to the serial number inputted by the user. Instead of using the mobile phone, the user may use other devices such as a computer to access the server 40.

Then, in step S3, the server 40 transmits the extension terminal setting information and additional setting change information of the extension terminal 10e to the access point 20 via the Internet 30. These pieces of information are transmitted using a file transfer means, such as a file transfer protocol (FTP), and stored in the memory 25 in the access point 20.

The additional setting change information indicates information required to change the system data of the terminal and includes such information as, as mentioned above, the procedure, various commands, and passwords for starting the system data changing program stored in the terminal, as well as commands to start a setting change application program. The server 40 controls such additional setting change information together with the extension terminal setting information.

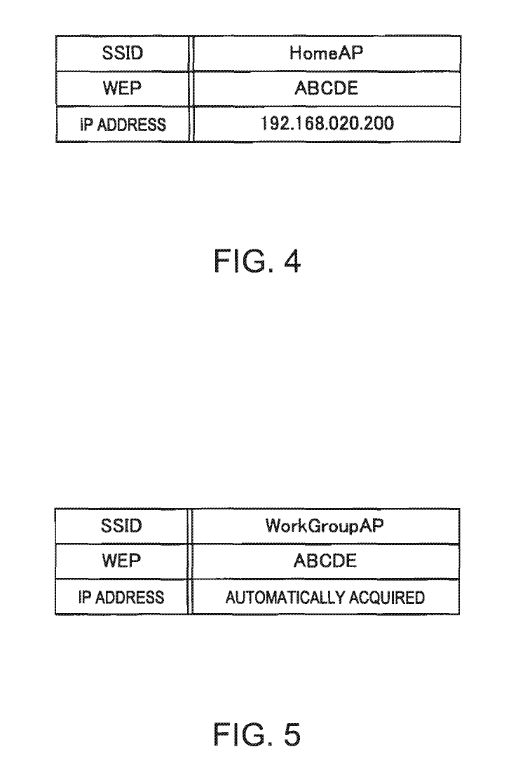

With reference to FIGS. 4 and 5, items included in the extension terminal setting information and the wireless LAN setting information will now be described.

FIG. 4 is a table showing one exemplary set of items of the extension terminal setting information established at the extension terminal. With reference to FIG. 4, in this embodiment., the extension terminal setting information includes a service set identifier (SSID), WEP, and an Internet protocol (IP) address.

The SSID mentioned here is an identifier used for identification of network composed of wireless LAN. Terminals sharing the same SSID can communicate with each other through the wireless LAN. For example, the SSID is set with 32 or fewer one-byte characters, and, in this embodiment, it is set as “homeAP.” Depending on products, the SSID may be referred to by other names such as ESSID, or enhanced service set ID.

The WEP indicates encryption technique standards established as an option of IEEE 802.11 that is the standard specifications for wireless LAN. Data is encrypted based on characters (e.g., five one-byte characters) as set by the user. In the embodiment, the WEP is set as “ABCDE.”

The IP address indicates an identification number allotted to the terminal to be connected to an IP network as represented by the Internet. A unique IP address is set for each terminal. In this embodiment, the IP address is set as “192.168.020.200.”

The items of the extension terminal setting information as set by the extension terminal 10e are not limited to the those shown in FIG. 4. As the encryption technique standards, WEP may be replaced by a temporal key integrity protocol (TKIP) or IEEE 802.1x, or there may be other items such as a media access control (MAC) address.

FIG. 5 is a table showing one exemplary set of items of the wireless LAN setting information established at the access point. System data is set at the access point 20 based on the existing wireless LAN setting information as shown in FIG. 5, until the access point 20 receives the extension terminal setting information of the extension terminal 10e from the server 40.

Referring to FIG. 5, the SSID is set as “WorkGroupAP,” WEP is set as “ABCDE,” and the IP address is set as “Automatically Acquired.” The system data is set at the terminals 10a to 10c, as is at the access point 20, based on the existing wireless LAN setting information. As a result, the terminals 10a to 10c are allowed to communicate via the access point 20.

Referring back to FIG. 3, at the completion of step 3, the memory 25 of the access point 20 has stored the extension terminal setting information and additional setting change information transmitted from the server 40, the existing wireless LAN setting information, and the setting change application program.

Then, in step S4, in substitution for the system data based on the existing wireless LAN setting information, the system data based on the extension terminal setting information transmitted from the server 40 is set at the access point 20 and validated. Alternatively, the system data based on the extension terminal setting information may be set by an operation such as rebooting.

The reboot operation may be performed automatically after a predetermined period of time or may be performed by a remote operation by the service provider through the Internet 30. Alternatively, the user may carry out the reboot operation after confirming that the extension terminal setting information and the additional setting change information have been successfully transmitted from the server 40 to the access point 20 by use of the LED lamp or the like of the access point 20.

The system data is set at the access point 20, as is at the extension terminal 10e, based on the extension terminal setting information. Accordingly, the access point 20 is allowed to communicate with the extension terminal 10e via the wireless LAN.

Next, in step S5, the access point 20 transmits the existing wireless LAN setting information and the additional setting change information to the extension terminal 10e. Because the existing wireless LAN setting information is encrypted and transmitted to the extension terminal 10e via the wireless LAN, the risk of leakage to the third party decreases. The access point 20 further starts the setting change application program stored in the memory 25.

The setting change application program stored in the memory 25 of the access point 20 starts the system data changing program stored in the extension terminal 10e, based on the existing wireless LAN setting information and additional setting change information transmitted to the extension terminal 10e. As a result, the system data of the terminal 10e is changed from the extension terminal setting information to the existing wireless LAN setting information. Alternatively, it may be the server 40 that stores the setting change application program and starts the system data changing program of the terminal 10e.

Then, in step S6, as the user restarts the extension terminal 10e, the system data that has been changed into the existing wireless LAN setting information is validated at the extension terminal 10e.

In step S7, based on the existing wireless LAN setting information stored in the memory 25, the access point 20 sets the system data of the access point 20. Alternatively, the system data as set based on the existing wireless LAN setting information may be validated by an operation such as rebooting.

Upon completion of step S7, the system data is set based on the existing wireless LAN setting information at the access point 20, the terminals 10a to 10c, and the extension terminal 10e, thereby allowing the wireless LAN communication. As described, by following the flow chart of FIG. 3, the extension terminal 10e is newly connected to the wireless LAN.

If the access point 20 as shown in FIG. 1 becomes a boundary point of the network between the Internet and the wireless LAN, it is desirable that a communication protocol such as a session initiation protocol (SIP) is mounted on the access point 20 so that a global IP address for the Internet 30 and a local IP address for the wireless LAN are exchangeable.

According to the embodiment, when connecting the extension terminal 10e to the wireless LAN, the user needs only to access the server 40 using e.g. the mobile phone without having to use a computer or input information such as that shown in FIGS. 4 and 5. Therefore, the user's burden is reduced.

Also, because the operation of connecting the extension terminal 10e to the wireless LAN starts when the user has accessed to the server 40 using e.g. the mobile phone, it is not easy for the third party to find that the connection of the extension terminal 10e is in operation. Therefore, the risk of leakage of information such as the extension terminal setting information to the third party is low. Also, because the extension terminal setting information and the additional setting change information are transmitted from the server 40 to the access point 20 through the Internet 30, the data is easily encrypted on the Internet 30.

Moreover, high security is realized at every communication pathway even when transmitting the existing wireless LAN setting information and the additional setting change information from the access point 20 to the extension terminal 10e, because the data is encrypted based on the extension terminal setting information. Even if the information such as the serial number stored at the server 40 is leaked to the third party, it is possible to avoid direct damages incurred by the leakage since it is difficult to identify the network, place, etc. at which the connected terminal 10e is located.

In the embodiment, because the existing wireless LAN setting information and the additional setting change information are transmitted from the access point 20 to the extension terminal 10e through the wireless LAN. There is no need to equip the extension terminal 10e with systems other than the wireless LAN, such as a universal serial bus (USB) interface, a wired LAN interface, radio frequency identification (RFID), or an infrared system. Further, as hereinbefore described, because the user does not need to perform an operation such as data inputting, he or she can connect a terminal such as a network camera or a portable game instrument having no keyboard to the wireless LAN as the extension terminal 10e.

In addition, in the embodiment, no special firmware or the like needs to be mounted on the extension terminal 10e, and only the serial number, the extension terminal setting information, and the additional setting change information concerning the extension terminal 10e need to be registered at the server 40. Accordingly, it is possible to realize the wireless LAN communication system to which the extension terminal is easily connected.

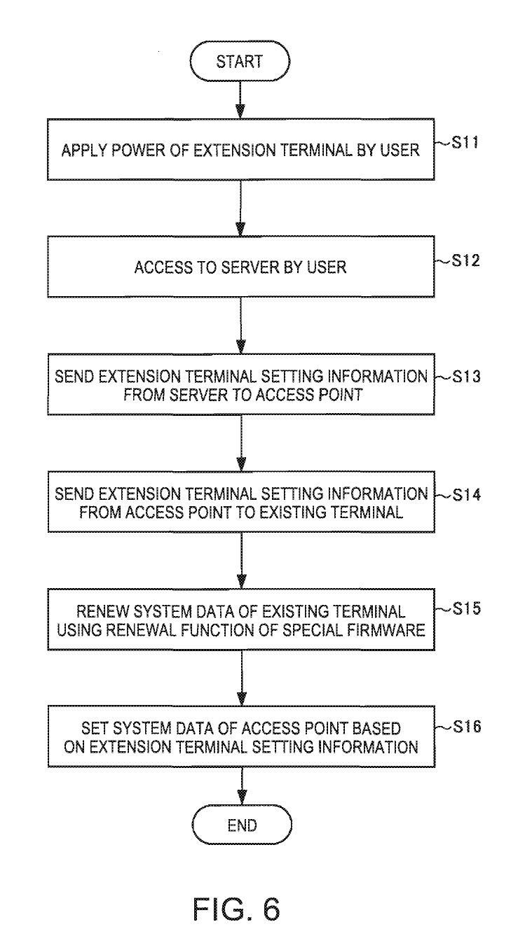

In contrast, a special firmware may be mounted on the terminals 10a to 10c. Described in the following is the second embodiment, in which a special firmware corresponding to the access point 20 is mounted on the terminals 10a to 10c and in which the system data of terminals 10a to 10c is changed based on the extension terminal setting information of the extension terminal 10e. FIG. 6 is a flow chart showing a method for setting a wireless LAN of the second embodiment of the invention.

Steps S11 and S12 in FIG. 6 are identical to steps S1 and S2 shown in FIG. 3. In step 13, the extension terminal setting information is transmitted from the server 40 to the access point 20. Step S4 as shown in FIG. 3 is not required because, at the access point 20, it only needs to change the system data of the terminals 10a to 10c at which the wireless LAN connection has already been established.

In step S14, the extension terminal setting information set at the extension terminal 10e is transmitted from the access point 20 to the terminals 10a to 10c. In step S15, the user renews the system data based on the extension terminal setting information using a renewal function of the special firmware mounted on the terminals 10a to 10c. Then, in step 16, the access point 20 sets the system data based on the extension terminal setting information stored in the memory 25.

As has been described, by changing the system data, the system data is set based on the extension terminal setting information at the access point 20, the terminals 10a to 10c, and the extension terminal 10e, and communication is thereby made possible via the wireless LAN. In this case, also, high security is realized as in the case described referring to FIG. 3, because every communication path that transmits the extension terminal setting information required when setting the system date is encrypted.

Described next is another exemplary structure of the wireless LAN communication system in which the method for setting the wireless LAN communication system of the first embodiment is implemented.

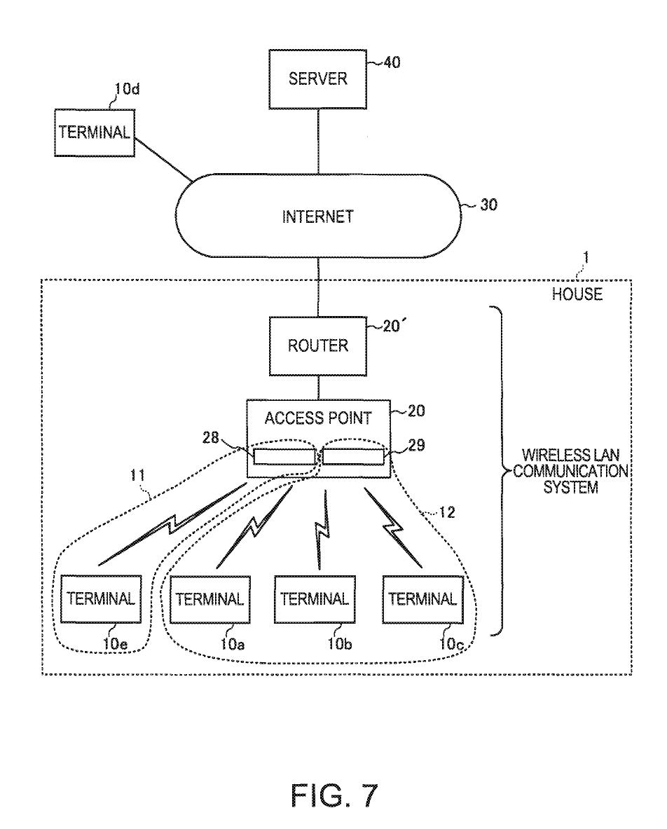

FIG. 7 is a block diagram showing another exemplary structure of the wireless LAN communication system. The structure as shown in FIG. 7 is identical to that in FIG. 1, except for transmit-receive sections 28 and 29 and wireless LAN 11 and 12.

Referring to FIG. 7, the transmit-receive sections 28 and 29 having a function to transmit/receive the wireless IAN signal are mounted on the access point 20. The transmit-receive section 28 is used in the wireless LAN 11 containing the extension terminal 10e, and the transmit-receive section 29 is used in the wireless LAN 12 containing the existing terminals 10a to 10c.

In this example, two types of wireless LAN 11 and 12 are provided. For example, the SSID is set as “homeAP” in the wireless LAN 11 and “WorkGroupAP” in the wireless LAN 12. Accordingly, by configuring the wireless LAN as shown in FIG. 7, the terminals 10a to 10c in the wireless LAN 12 are allowed to perform the wireless LAN communication via the access point 20 even in the middle of transmitting the existing wireless LAN setting information and additional setting change information to the extension terminal 10e.

What is claimed is:

1. A method of setting a new terminal to a network communication system via an access point, a first system data being system data of the access point, a second system data being system data of the new terminal, the method comprising:
(a) acquiring an information of the new terminal at a server of the local area network communication system;
(b) transmitting a second setting information regarding the new terminal from the server to the access point;
(c) modifying the first system data according to the second setting information;
(d) transmitting a first setting information from the access point to the new terminal, the first setting information including a setting information of the network communication system;
(e) modifying second system data according to the first setting information; and
(f) modifying the first system data according to the first setting information.

2. A method of setting a new terminal to a network communication system via an access point, comprising:
(a) acquiring an information of the new terminal at a server of the network communication system;
(b) transmitting a setting information regarding the new terminal from the server to the access point;
(c) transmitting the setting information from the access point to one existing terminal;
(d) renewing first system data according to the setting information, the first system data being system data of the one existing terminal; and
(e) modifying second system data according to the setting information, the second system data being system data of the access point.

3. The method according to claim 1,
the step (a) including acquiring an information of the new terminal at a server from a user's mobile phone or computer.

4. An access point of a network communication system, comprising:
a storage that stores a second setting information regarding a new terminal and a first setting information including a setting information of a network communication system;
a transmitter-receiver that transmits a first wireless signal to at least one terminal and receives a second wireless signal from the at least one terminal; and
a controller that, acquires the second setting information from a server of the network communication system, sets first system data according to the second setting information, the first system data being system data of the access point, controls the transmitter-receiver so as to transmit the first setting information to the new terminal so that second system data is modified according to the first setting information, the second system data being system data of the new terminal, and modifies the first system data according to the first setting information.

5. The access point of a network communication system according to claim 4,
the transmitter-receiver including a first transmit-receive section that transmits a third wireless signal to at least one existing terminal and receives a fourth wireless signal from the at least one existing terminal, and a second transmit-receive section that transmits a fifth wireless signal to the new terminal and receives a sixth wireless signal from the new terminal.
